(19) United States
(12) Patent Application Publication
(10) Pub. No.: US 2025/0322647 A1
(43) Pub. Date: Oct. 16, 2025

(54) METHOD AND APPARATUS WITH FEATURE EXTRACTION

(71) Applicants: Samsung Electronics Co., Ltd., Suwon-si (KR); Korea Advanced Institute of Science and Technology, Daejeon (KR)

(72) Inventors: Jong-Sok KIM, Suwon-si (KR); JunSung PARK, Daejeon (KR); Seung Tae KHANG, Suwon-si (KR); SeongOok PARK, Daejeon (KR)

(73) Assignees: Samsung Electronics Co., Ltd., Suwon-si (KR); Korea Advanced Institute of Science and Technology, Daejeon (KR)

(21) Appl. No.: 18/925,932

(22) Filed: Oct. 24, 2024

(30) Foreign Application Priority Data
Apr. 11, 2024 (KR) 10-2024-0048879

(51) Int. Cl. G06V 10/77; G01S 13/89; G06V 10/82

(52) U.S. Cl. CPC G06V 10/7715; G01S 13/89; G06V 10/82

(57) ABSTRACT

A feature extraction method is provided. The feature extraction method includes applying a first feature extracted from multi-channel input data to a bottleneck-based block included in a first type of path of a neural network and obtaining a second feature including a reduced parameter compared to the first feature, upsampling a derived feature of the second feature obtained based on a layer included in a second type of path of the neural network to correspond to a size of a derived feature of the first feature, and obtaining an intermediate feature applied to a head for a task of the neural network, based on the upsampled derived feature of the second feature and the derived feature of the first feature.

### CROSS-REFERENCE TO RELATED APPLICATIONS

This application claims the benefit under 35 USC § 119(a) of Korean Patent Application No. 10-2024-0048879, filed on Apr. 11, 2024, in the Korean Intellectual Property Office, the entire disclosure of which is incorporated herein by reference for all purposes.

### BACKGROUND

### 1. Field

The following description relates to a method and apparatus with feature extraction.

### 2. Description of Related Art

A neural network may be automatically trained from training data. The trained neural network may embody or learn useful information in the training data. By this process a neural network can learn to identify various patterns, characteristics, and structures in new data. The trained neural network is generally able to convert high-dimensional input data into low-dimensional meaningful information (features). In a neural network, an increase in the number of parameters during the feature extraction process may cause overfitting or an increase in computational costs and memory requirements, thus reducing the effectiveness and accuracy of the neural network. For example, a neural network for processing multi-channel input data, for example a model for processing data from a multi-input multi-output (MIMO) radar system (e.g., to detect vehicles, delineate a drivable space, etc.) may use a large amount of parameters for feature extraction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples may provide a feature extraction method of efficiently using parameters and/or a feature extraction block for a neural network.

However, the technical aspects are not limited to the aforementioned aspects, and other technical aspects may be present.

In one general aspect, a feature extraction method is performed by one or more processors and the method includes: applying a first feature, which is extracted from multi-channel input data, to a bottleneck-based block included in a first type of path in a neural network, wherein the bottleneck-based block includes a squeeze and excitation (SE) block, and obtaining a second feature having a parameter that is less than a corresponding parameter of the first feature; upsampling a second derived feature, the second derived feature derived from the second feature derived from the second feature based on a layer included in a second type of path of the neural network, the upsampling causing the second derived feature to correspond to a size of a first derived feature derived from the first feature; and obtaining an intermediate feature applied to a head for a task of the neural network, based on the upsampled second derived feature and the first derived feature.

The bottleneck-based block may include: a layer configured to perform a pointwise convolution operation; a layer configured to perform a depthwise convolution operation; and an SE block configured to perform a squeeze operation and an excitation operation.

The upsampling of the second derived feature may include: applying the second feature to the bottleneck-based block included in the first type of path to obtain a third feature having a reduced number of parameters as compared to the second feature; upsampling a third derived feature derived from the third feature to a size of the second derived feature; and upsampling the second derived feature converted based on the upsampled third derived feature to correspond to the size of the first derived feature.

The bottleneck-based block, in which a size of input data thereof is equal to a size of output data thereof, may include an SE block configured to receive, as an input, an output of a layer configured to perform a depthwise convolution operation.

The bottleneck-based block, in which a size of input data thereof is different to a size of output data thereof, may include a layer configured to perform a depthwise convolution operation of receiving an output of an SE block as an input.

The bottleneck-based block, in which a size of input data thereof is equal to a size of output data thereof, may include a skip connection between two layers of the bottleneck-based block.

An activation function may not be applied to output data of a layer of the bottleneck-based block that is configured to perform a depthwise convolution operation.

The first derived feature may be obtained by applying the first feature to the layer included in the second type of path.

The obtaining of the intermediate feature may include concatenating the upsampled second derived feature with the first derived feature to form the intermediate feature.

The task may be object detection, and the method may further include: converting the intermediate feature into a feature corresponding to the task of object detection; and based on the converted feature, outputting an object detection result corresponding to the multi-channel input data.

The multi-channel input data may include data sensed by a radar.

The task may include an object detection task or an object recognition task.

A non-transitory computer-readable storage medium may store instructions that, when executed by the one or more processors, cause the one or more processors to perform any of the methods.

In another general aspect, an apparatus includes: one or more processors configured to: apply a first feature, which is extracted from multi-channel input data, to a bottleneck-based block included in a first type of path in a neural network, wherein the bottleneck-based block includes a squeeze and excitation (SE) block, and obtain a second feature having a parameter that is less than a corresponding parameter of the first feature; upsample a second derived feature, the second derived feature derived from the second feature based on a layer included in a second type of path of the neural network, the upsampling causing the second derived feature to correspond to a size of a first derived feature derived from the first feature; and obtain an intermediate feature applied to a head for a task of the neural network, based on the upsampled second derived feature and the first derived feature.

The bottleneck-based block may include: a layer configured to perform a pointwise convolution operation; a layer configured to perform a depthwise convolution operation; and an SE block configured to perform a squeeze operation and an excitation operation.

For upsampling of the second derived feature, the one or more processors are further configured to: apply the second feature to the bottleneck-based block included in the first type of path to obtain a third feature having a reduced number of parameters as compared to the second feature; upsample a third derived feature derived from the third feature to a size of the second derived feature; and upsample the second derived feature converted based on the upsampled third derived feature to correspond to the size of the first derived feature.

The task may be object detection, and the one or more processors may be further configured to: convert the intermediate feature into a feature corresponding to the task of object detection; and based on the converted feature, output an object detection result corresponding to the multi-channel input data.

A bottleneck-based block, in which a size of input data thereof is equal to a size of output data thereof, may include an SE block configured to receive, as an input, an output of a layer configured to perform a depthwise convolution operation.

A bottleneck-based block, in which a size of input data thereof is different that a size of output data thereof, may include a layer configured to perform a depthwise convolution operation of receiving, as an input, an output of an SE block.

An activation function may be not applied to output data of a layer of the bottleneck-based block that is configured to perform a depthwise convolution operation.

Other features and aspects will be apparent from the following detailed description, the drawings, and the claims.

### BRIEF DESCRIPTION OF THE DRAWINGS

FIG. 1 illustrates an example feature extraction method, according to one or more embodiments.

FIG. 2A illustrates an example pointwise convolution operation, according to one or more embodiments.

FIG. 2B illustrates an example depthwise convolution operation, according to one or more embodiments.

FIGS. 3A and 3B illustrate examples of a bottleneck-based block, according to one or more embodiments.

FIG. 3C illustrates an example structure of an SE block, according to one or more embodiments.

FIG. 4 illustrates an example structure of a neural network for feature extraction, according to one or more embodiments.

FIG. 5 illustrates an example structure of a head for a task, according to one or more embodiments.

FIG. 6 illustrates an example feature extraction method including operations of object detection, according to one or more embodiments.

FIG. 7 illustrates an example of a configuration of an apparatus, according to one or more embodiments.

Throughout the drawings and the detailed description, unless otherwise described or provided, the same or like drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

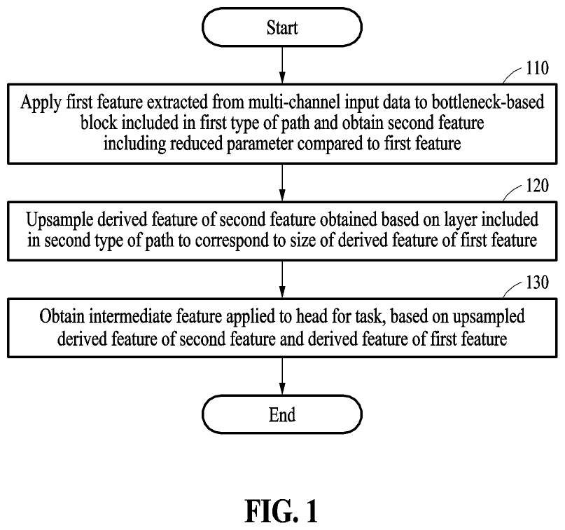

FIG. 1 illustrates an example feature extraction method, according to one or more embodiments.

A feature extraction method according to an example may correspond to an operation method for extracting a feature in a neural network (sometimes referred to as “network”). A neural network may include one or more layers of nodes for feature extraction. For example, a feature may correspond to a feature map of C×H×W. C may be the size of a channel, H may be the size of a height, and W may be the size of a width. C may correspond to a channel axis and H×W may correspond to a spatial axis.

Referring to FIG. 1, the example extraction may include applying a first feature, which is extracted from multi-channel input data, to a bottleneck-based block included in a first type of path of the network and obtaining a second feature including a reduced parameter (reduced as compared to the first feature, e.g., having fewer parameters, dimensions, etc.). The bottleneck-based block may include a squeeze and excitation (SE) block.

The first type of path may be a type of a sequence of layer(s) in the network through which passes a feature that has been extracted from the neural network. The first type of path may include one or more layers. The first type of path may include/be the aforementioned bottleneck-based block. The first type of path may include/be a passing path. The first type of path is described in detail below.

The multi-channel input data may be input data of a neural network and may include a plurality of channels. For example, the multi-channel input data may include data sensed by a radar, and three channels may correspond to range, azimuth, and Doppler, respectively. The data sensed by a radar is only an example of multi-channel input data, and the multi-channel input data may include data from the plurality of channels of various types, such as red, green, and blue (RGB) data.

The term “block”, in reference to the neural network, refers to a set of one or more layers for performing an operation of a specific purpose. A block included in the neural network may include/be the bottleneck-based block. The bottleneck-based block may be a model based on a bottleneck structure of a residual network (ResNet) model and may include the SE block. For example, the bottleneck-based block may include one or more layers for performing an operation of the bottleneck-based block and an operation of the SE block.

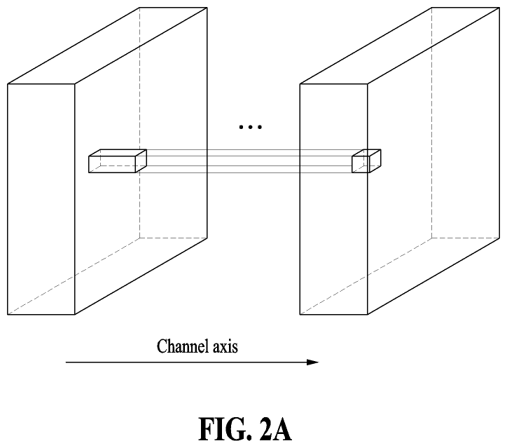

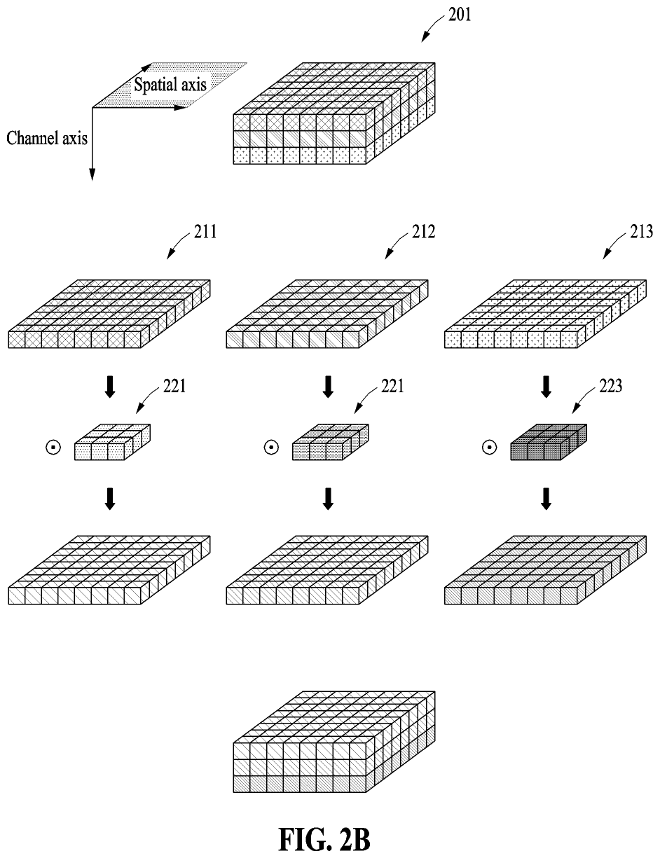

The bottleneck-based block according to an example may include a layer for a pointwise convolution operation (e.g., convolution over a channel dimension), a layer for a depthwise convolution operation (e.g., a convolution over a spatial dimension), and an SE block for a squeeze operation and an excitation operation. The pointwise convolution operation may be a convolution operation in a direction of a channel axis. For example, referring to FIG. 2A, the pointwise convolution operation may be an inter-channel convolution operation using a kernel of size 1×1. The depthwise convolution operation may be a convolution operation on a feature map of a spatial axis. For example, referring to FIG. 2B, the depthwise convolution operation may use two-dimensional kernels 221, 222, and 223 of size 3×3 obtained by separating a kernel of size 3×3×c (c is the size of a channel of an input feature) for each channel and may include a convolution operation performed on feature maps 211, 212, and 213 of each channel of an input feature 201. A structure of the bottleneck-based block and specific operations performed in the bottleneck-based block are described in detail below.

Referring again to FIG. 1, the first feature extracted from the multi-channel input data may be applied to the bottleneck-based block to obtain a second feature. The bottleneck-based block may perform an operation of reducing parameters (or dimensionality) of input data. The second feature, which is an output of the bottleneck-based block, may be data with a reduced number of parameters compared to the first feature, which is an input of the bottleneck-based block.

The feature extraction method may include operation 120 of (i) upsampling a derived feature of the second feature obtained based on a layer included in a second type of path (ii) to correspond to the size of a derived feature of the first feature.

The second type of path is a type of a sequence of layer(s) through which passes a feature that has been extracted from a neural network; the second type of path may be separated from (e.g., not overlap) the first type of path. The second type of path may include one or more layers of the network. For example, the second type of path may include a layer for a transpose operation. For example, the second type of path may include a layer for an operation of concatenating features with a channel axis. The second type of path is described in detail below.

A same feature may be applied to a layer included in the first type of path and the layer included in the second type of path. As a result of the feature being applied to multiple types of paths, multiple features corresponding to the feature may be outputted.

The derived feature of the first feature may include/be a feature obtained by applying the first feature to the layer(s) included in the second type of path. The second feature may be a feature obtained as a result of passing the first feature through the layer(s) included in the first type of path. The derived feature of the first feature may be a feature obtained as a result of passing the first feature through the layer(s) included in the second type of path.

The second feature may be applied to the layer(s) included in the first type of path. This is described in detail below.

The layer included in the first type of path for receiving the first feature as an input may be different from the layer included in the first type of path for receiving the second feature as an input. The layer included in the second type of path for receiving the first feature as an input may be different from the layer included in the second type of path for receiving the second feature as an input.

The derived feature of the second feature may be upsampled to the size of the derived feature of the first feature. The size of at least one axis (dimension) of the derived feature of the second feature (second derived feature) may be smaller than that of the derived feature of the first feature (first derived feature). For example, when the size of the second derived feature is C×H×W (C, H, and W are each arbitrary natural numbers) and the size of the first derived feature is C×2H×W, the second derived feature may be upsampled to be in the C×2H×W size.

The feature extraction method according to an example may include operation 130 of obtaining an intermediate feature applied to a head for a task, based on the upsampled second derived feature and the first derived feature.

Operation 130 of obtaining the intermediate feature may include concatenating the upsampled second derived feature with the first derived feature to obtain the intermediate feature. For example, the second derived feature that is upsampled to the same size as the first derived feature may be concatenated to a channel axis of the first derived feature. A feature in which the upsampled second derived feature is concatenated with the first derived feature may be output as the intermediate feature.

The intermediate feature may be applied to a head for a task to obtain final output data corresponding to the task. For example, the task may include an object detection task. Multi-channel input data may correspond to image data or radar data, as non-limiting examples. An intermediate feature extracted from the multi-channel input data may be applied to a head for completion of the object detection task to obtain an object detection result corresponding to input data. The object detection task is only an example of a task, and the task may include various tasks of a neural network, such as an object recognition task and a segmentation task.

Operation 120 of upsampling the second derived feature (to correspond to the size of the first derived feature) may (i) include applying the second feature to the bottleneck-based (block included in the first type of path) to obtain a third feature including a reduced parameter (reduced as compared to the second feature), (ii) upsampling a derived feature of the third feature (third derived feature) (obtained based on the layer included in the second type of path) to correspond to the size of the second derived feature, and (iii) upsampling the second derived feature (converted based on the upsampled third derived feature) to correspond to the size of the first derived feature.

The third feature may be a feature obtained as a result of passing the second feature through the layer(s) included in the first type of path. The obtaining of the third feature may correspond to operation 110 corresponding to the second feature (that is, the third feature may be obtained in similar fashion as the second feature). In other words, the second feature may be obtained as a result of passing the first feature through the layer(s) included in the first type of path. The third feature may be obtained as a result of passing the second feature through the layer(s) included in the first type of path.

The third derived feature may be obtained by applying the third feature to the layer included in the second type of path. The upsampling of the third derived feature to correspond to the size of the derived feature of the third feature may correspond to operation 120 of the second feature (that is, the same process may be performed). The third derived feature may be upsampled to the size of the second derived feature.

The second derived feature may be converted by concatenating the upsampled third derived feature with the second derived feature. The converted second derived feature may be upsampled to correspond to the size of the first derived feature.

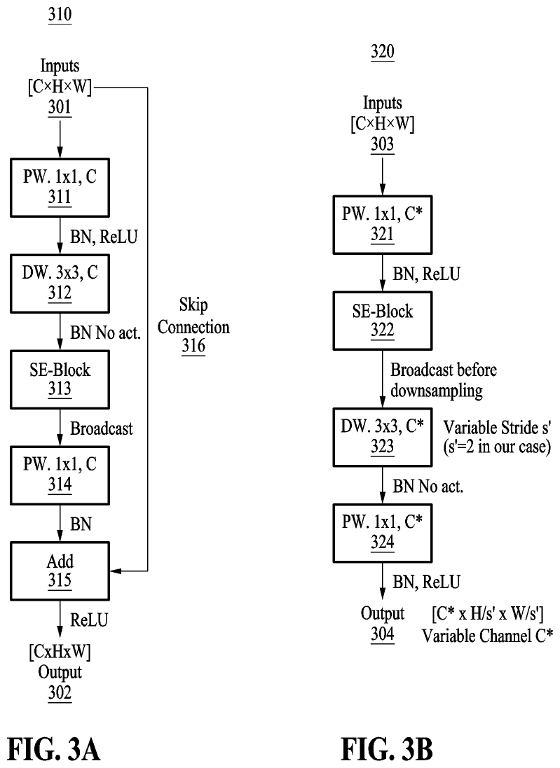

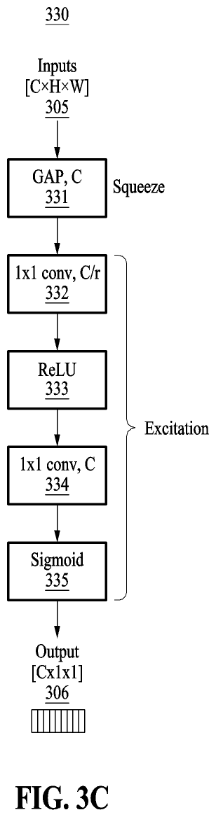

FIGS. 3A and 3B illustrate examples of a bottleneck-based block, according to one or more embodiments.

Referring to FIG. 3A, a bottleneck-based block 310 may include layers 311 and 314 for a pointwise (PW) convolution operation, a layer 312 for a depthwise (DW) convolution operation, and an SE block 313.

For example, the layers 311 and 314 for a PW convolution operation may perform an inter-channel convolution operation of data inputted to the layers 311 and 314 using a kernel of size 1×1. Information about the relationship between channels may be trained into the operation of the layers 311 and 314 for performing a PW convolution operation.

For example, the layer 312 for a DW convolution operation may perform a convolution operation on a matrix of each channel of input data using a kernel of size 3×3. Spatial information may be used to train the operation of the layer 312 for a DW convolution operation.

The bottleneck-based block 310 may be configured such that input data 301 and output data 302 have the same size. The bottleneck-based block 310 (in which the input data 301 and the output data 302 have the same size) may include the SE block 313 for receiving, as an input, an output of the layer 312 for a DW convolution operation. In other words, an order of the SE block 313 in a sequence of layers included in the bottleneck-based block 310 may be lower (i.e., after/later) than an order of the layer 312.

According to an example, the bottleneck-based block 310 in which the input data 301 and the output data 302 have the same size may include a skip connection 316. Relatedly, the bottleneck-based block 310 may also include a layer 315 for a residual operation of adding the input data 301 to an operation result of layers 311, 312, 313, and 314.

According to an example, an activation function may not be applied to output data of the layer 312. This is to prevent information loss due to the activation function. The activation function (e.g., a rectified linear unit (ReLU)) may be applied to output data of each of layers 311, 313, 314, and 315 (but not the layer 312) included in the bottleneck-based block 310.

Referring to FIG. 3B, a bottleneck-based block 320 may include layers 321 and 324 for a PW convolution operation, a layer 323 for a DW convolution operation, and an SE block 322.

The bottleneck-based block 320 may be a block in which input data 303 and output data 304 have different sizes. For example, the size of a channel (number of channels) of the input data 303 may be C and the size of a channel of the output data 304 may be C*(C*≠C). In other words, the bottleneck-based block 320 may be a block for outputting the output data 304 in which the size of the input data 303 is converted.

The bottleneck-based block 320 in which the input data 303 and the output data 304 have different sizes may include the layer 323 for a DW convolution operation for receiving an output of the SE block 322 as an input. In other words, an order of the SE block 322 in a sequence of the layers included in the bottleneck-based block 320 may be higher (i.e., before/earlier) than an order of the layer 323 for a DW convolution operation.

According to an example, the bottleneck-based block 320 in which the input data 303 and the output data 304 have different sizes may not include a skip connection, and may differ from the bottleneck-based block 310 whose input data 301 and the output data 302 have the same size, as shown in FIG. 3A.

According to an example, an activation function may not be applied to output data of the layer 323 for a DW convolution operation. This may prevent information loss that can be caused by an activation function. The activation function (e.g., a ReLU) may be applied to output data of each of layers 321, 322, and 324 (but not the layer 323).

FIG. 3C illustrates example structure of an SE block, according to one or more embodiments.

Referring to FIG. 3C, an SE block 330 according to an example may include a layer 331 for a squeeze operation and layers 332, 333, 334, and 335 for an excitation operation.

For example, the layer 331 (for a squeeze operation) may output importance or weight of each channel of input data 305 through a global average pooling (GAP) operation.

The layers 332 and 334 may be configured for performing convolution operations using a 1×1 kernel, and the layers 333 and 335 of an excitation function may output redefined importance between channels based on the importance of each channel output by the layer 331. The layer 332 may reduce “C” channels of the input data 305 to “C/r” channels through a convolution operation. Here, “r” may be a constant predetermined as a hyperparameter. A feature as reduced to “C/r” channels may be transmitted to the layer 333 and an ReLU function may be used. Application of the layer 334 to a feature to which the ReLU function has been applied may convert the size of a channel of the feature back to C through a convolution operation of the layer 334. Output data 306 of size C×1×1 and having values in a range of [0 to 1) may be obtained by inputting the feature output from the layer 334 to a sigmoid function in the layer 335.

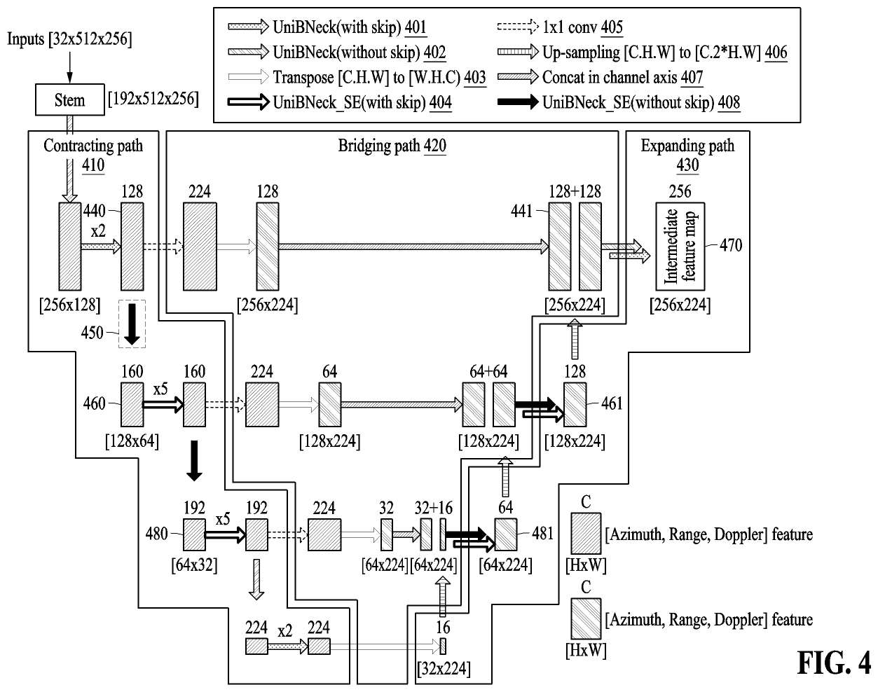

FIG. 4 illustrates an example structure of a neural network for feature extraction, according to one or more embodiments.

Referring to FIG. 4, a neural network for feature extraction according to an example may include sequence of layers that are divided into a contracting path 410, a bridging path 420, and an expanding path 430. The contracting path 410 may correspond to the first type of path described above. The bridging path 420 may correspond to the second type of path described above.

Referring to FIG. 4, a first arrow type 401 (see legend) indicates a first type of bottleneck block that includes a skip connection and does not include an SE block. A second arrow type 402 indicates a second type of bottleneck block that does not include a skip connection and does not include an SE block. A third arrow type 403 indicates a transpose block for performing a transpose operation of converting a [C, H, W] matrix to a [W, H, C] matrix. A fourth arrow type 404 indicates a first type of bottleneck-based block that includes a skip connection and an SE block. A fifth arrow type 405 indicates a convolution block for performing a convolution operation using a 1×1 kernel. A sixth arrow type 406 indicates an upsampling block for performing an upsampling operation of converting the [C, H, W] matrix to a [C, 2H, W] matrix. A seventh arrow type 407 indicates a connection block for performing a connection operation of a channel axis. An eighth arrow type 408 indicates a second type of bottleneck-based block that does not include a skip connection and includes an SE block.

In the contracting path 410 according to an example, an operation of outputting reduced parameters may be repeated, and thus, the ability to obtain a high resolution feature and a high level feature in a spatial aspect may be trained. In the expanding path 430, features may be upsampled and concatenated with all features trained in the contracting path 410 through the bridging path 420.

For example, a first feature 440 may be applied to a second type of bottleneck-based block 450 included in the contracting path 410 to output a second feature 460 that includes reduced parameters (as compared to the first feature 440). The second type of bottleneck-based block 450 may correspond to the bottleneck-based block 320 shown in FIG. 3B in which input data and output data have different sizes. The second type of bottleneck-based block 450 may not include a skip connection.

The first feature 440 may be applied to one or more bottleneck blocks of the first type and layer(s) included in the bridging path 420 to obtain a first derived feature 441 (derived from the first feature).

A second derived feature 461 may be derived from the second feature 460 and may be obtained in the same operation as the obtaining the first derived feature 441 from the first feature 440. The second derived feature 460 may be applied to one or more bottleneck-based blocks of the first type and the layer(s) included in the bridging path 420 to obtain the second derived feature 461.

The second derived feature 461 may be upsampled through the expanding path 430 and may be concatenated with the first derived feature 441. An intermediate feature 470 may be obtained based on concatenated features.

The second derived feature 461 may be generated by being concatenated with a third derived feature 481 derived from a third feature 480. The third feature 480 may be obtained through the same operation as the obtaining the second feature 460 from the first feature 440. The third derived feature 481 may be obtained through the same operation as the obtaining the first derived feature 441 and the second derived feature 461.

To generalize and describe an operation of a neural network for feature extraction, an (n+1)-th feature may be obtained from an n-th feature through the contracting path 410 and a derived feature of the n-th feature may be obtained through the bridging path 420. A derived feature of an (n+1)-th feature obtained from the (n+1)-th feature through the bridging path 420 may be upsampled through the expanding path 430 and may be concatenated with the derived feature from the n-th feature, and in this way the derived feature of the n-th feature may be converted. The converted derived feature of the n-th feature may be upsampled through the expanding path 430 and may be concatenated with the derived feature of the (n−1)-th feature.

The size of features and the arrangement and structure of blocks shown in FIG. 4 are only examples of a neural network structure, and the structure of a neural network is not limited thereto. The structure of a neural network may include various structures of outputting a second feature from a first feature through a bottleneck-based block, upsampling a derived feature of the second feature obtained by applying the second feature to one or more layers, and concatenating the derived feature of the second feature with a derived feature of the first feature.

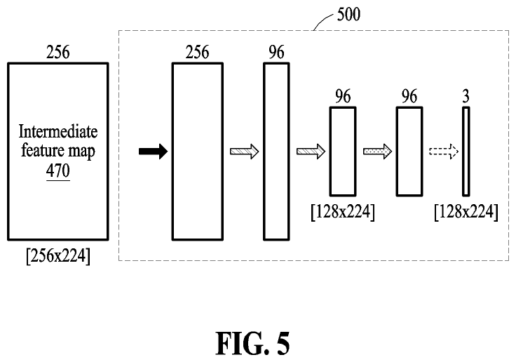

The intermediate feature 470 obtained from the neural network for feature extraction may be applied to a head for a task. For example, referring to FIG. 5, the intermediate feature 470 may be applied to a head 500 for a task and may be converted into a feature corresponding to the task. A result corresponding to the task may be output from the feature corresponding to the task. The head 500 may include one or more layers and may output a final inference result of the network. The structure of the head 500 shown in FIG. 5 is only an example and not limited thereto.

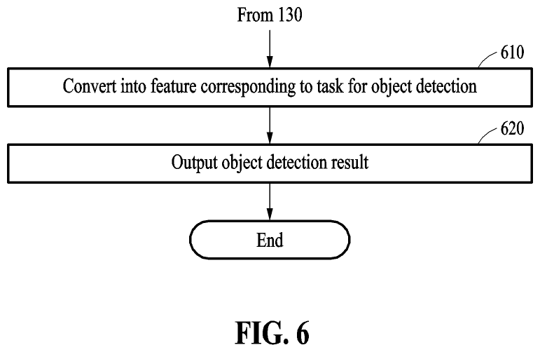

FIG. 6 illustrates an example feature extraction method including operations of object detection, according to one or more embodiments.

A feature extraction method according to an example may be used in a task for object detection. The head to which the intermediate feature obtained by the above-described feature extraction method is applied may be configured for an object detection task.

Multi-channel input data may include light detection and ranging (LiDAR) data. LiDAR data may be data sensed from a LiDAR sensor and may include, for example, data about a surrounding environment of a vehicle on which the LiDAR is installed. For example, the feature extraction method including operations for object detection may be used for autonomous driving of a vehicle.

The feature extraction method according to an example may further include operation 610 of converting an intermediate feature performed after operation 130 of FIG. 1 into a feature corresponding to a task for object detection and operation 620 of outputting an object detection result. For example, operations 610 and 620 may be performed in a head for an object detection task. For example, the head for an object detection task may include one or more layers trained to output the object detection result from the intermediate feature.

Operation 620 of outputting the object detection result may include outputting the object detection result corresponding to multi-channel input data based on the converted feature. For example, the object detection result may include information about an object (or objects) detected in a surrounding environment of a vehicle in which a radar is installed. For example, information about the detected object may include class information of the detected object (e.g., vehicle, person, lane, etc.) and location information of the detected object (e.g., size, distance from ego, etc.).

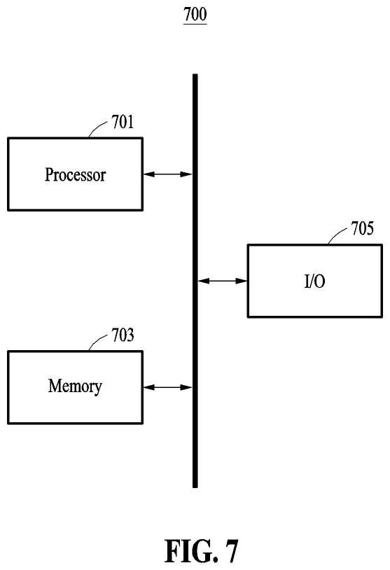

FIG. 7 illustrates an example configuration of an apparatus, according to one or more embodiments.

Referring to FIG. 7, an apparatus 700 according to an example may include a processor 701, a memory 703, and an input/output (I/O) device 705. The apparatus 700 may include an apparatus for performing the feature extraction method described above with reference to FIGS. 1 to 6. In practice, the processor 701 may be one or more of a variety of processors (examples are mentioned below).

The processor 701 may perform at least one operation of the feature extraction method described above with reference to FIGS. 1 to 6. For example, the processor 701 may perform applying a first feature extracted from multi-channel input data to a bottleneck-based block included in a first type of path to obtain a second feature including a reduced parameter compared to the first feature, upsampling a derived feature of the second feature obtained based on a layer included in a second type of path to correspond to the size of a derived feature of the first feature, and/or obtaining an intermediate feature applied to a head for a task, based on the upsampled derived feature of the second feature and the derived feature of the first feature.

The memory 703 according to an example may be a volatile or non-volatile memory (but not a signal per se) and may store data related to the feature extraction method described above with reference to FIGS. 1 to 6. For example, the memory 703 may store data generated during the process of performing the feature extraction method or data necessary for performing the feature extraction method. For example, the memory 703 may store a parameter of a neural network layer and a parameter of a head layer for feature extraction.

The memory 703 may not be a component of the apparatus 700 and may be included in an external device accessible by the apparatus 700. In this case, the apparatus 700 may receive data stored in the memory 703 included in the external device and transmit data to be stored in the memory 703 through the communication module.

According to an example, the memory 703 may store a program configured to implement the multi-task processing method described above with reference to FIGS. 1 to 6. The processor 701 may execute a program stored in the memory 703 and may control the apparatus 700. Code of the program executed by the processor 701 may be stored in the memory 703.

The apparatus 700 may exchange data with a user or an external device (e.g., a personal computer or a network) through the I/O device 705. For example, the apparatus 700 may receive multi-channel input data through the I/O device 705 and may output a performance result of a task obtained based on the extracted intermediate feature or the intermediate feature.

The apparatus 700 may further include other components not shown in the drawings. For example, the apparatus 700 may further include a communication module that provides functions for communicating with other electronic devices or other servers. In other words, the apparatus 700 may be connected to an external device (e.g., a terminal of a user, a server, or a network) through the communication module and exchange data with the external device. In addition, for example, the apparatus 700 may further include other components such as a transceiver, various sensors, and a database.

The computing apparatuses, the electronic devices, the processors, the memories, the sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A feature extraction method performed by one or more processors, the method comprising:
applying a first feature, which is extracted from multi-channel input data, to a bottleneck-based block included in a first type of path in a neural network, wherein the bottleneck-based block includes a squeeze and excitation (SE) block, and obtaining a second feature having a parameter that is less than a corresponding parameter of the first feature;
upsampling a second derived feature, the second derived feature derived from the second feature derived from the second feature based on a layer included in a second type of path of the neural network, the upsampling causing the second derived feature to correspond to a size of a first derived feature derived from the first feature; and
obtaining an intermediate feature applied to a head for a task of the neural network, based on the upsampled second derived feature and the first derived feature.

2. The feature extraction method of claim 1, wherein the bottleneck-based block comprises:
a layer configured to perform a pointwise convolution operation;
a layer configured to perform a depthwise convolution operation; and
an SE block configured to perform a squeeze operation and an excitation operation.

3. The feature extraction method of claim 1, wherein the upsampling of the second derived feature comprises:
applying the second feature to the bottleneck-based block included in the first type of path to obtain a third feature having a reduced number of parameters as compared to the second feature;
upsampling a third derived feature derived from the third feature to a size of the second derived feature; and
upsampling the second derived feature converted based on the upsampled third derived feature to correspond to the size of the first derived feature.

4. The feature extraction method of claim 1, wherein
the bottleneck-based block, in which a size of input data thereof is equal to a size of output data thereof, comprises an SE block configured to receive, as an input, an output of a layer configured to perform a depthwise convolution operation.

5. The feature extraction method of claim 1, wherein
the bottleneck-based block, in which a size of input data thereof is different to a size of output data thereof, comprises a layer configured to perform a depthwise convolution operation of receiving an output of an SE block as an input.

6. The feature extraction method of claim 1, wherein
the bottleneck-based block, in which a size of input data thereof is equal to a size of output data thereof, comprises a skip connection between two layers of the bottleneck-based block.

7. The feature extraction method of claim 1, wherein
an activation function is not applied to output data of a layer of the bottleneck-based block that is configured to perform a depthwise convolution operation.

8. The feature extraction method of claim 1, wherein
the first derived feature is obtained by applying the first feature to the layer included in the second type of path.

9. The feature extraction method of claim 1, wherein
the obtaining of the intermediate feature comprises concatenating the upsampled second derived feature with the first derived feature to form the intermediate feature.

10. The feature extraction method of claim 1, wherein the task is object detection, and the method further comprises:
converting the intermediate feature into a feature corresponding to the task of object detection; and
based on the converted feature, outputting an object detection result corresponding to the multi-channel input data.

11. The feature extraction method of claim 1, wherein
the multi-channel input data comprises data sensed by a radar.

12. The feature extraction method of claim 1, wherein the task comprises an object detection task or an object recognition task.

13. A non-transitory computer-readable storage medium storing instructions that, when executed by the one or more processors, cause the one or more processors to perform the method of claim 1.

14. An apparatus comprising:
one or more processors configured to:
apply a first feature, which is extracted from multi-channel input data, to a bottleneck-based block included in a first type of path in a neural network, wherein the bottleneck-based block includes a squeeze and excitation (SE) block, and obtain a second feature having a parameter that is less than a corresponding parameter of the first feature;
upsample a second derived feature, the second derived feature derived from the second feature based on a layer included in a second type of path of the neural network, the upsampling causing the second derived feature to correspond to a size of a first derived feature derived from the first feature; and
obtain an intermediate feature applied to a head for a task of the neural network, based on the upsampled second derived feature and the first derived feature.

15. The apparatus of claim 14, wherein the bottleneck-based block comprises:
a layer configured to perform a pointwise convolution operation;
a layer configured to perform a depthwise convolution operation; and
an SE block configured to perform a squeeze operation and an excitation operation.

16. The apparatus of claim 14, wherein for upsampling of the second derived feature, the one or more processors are further configured to:
apply the second feature to the bottleneck-based block included in the first type of path to obtain a third feature having a reduced number of parameters as compared to the second feature;
upsample a third derived feature derived from the third feature to a size of the second derived feature; and
upsample the second derived feature converted based on the upsampled third derived feature to correspond to the size of the first derived feature.

17. The apparatus of claim 14, wherein the task is object detection, and wherein the one or more processors are further configured to:
convert the intermediate feature into a feature corresponding to the task of object detection; and
based on the converted feature, output an object detection result corresponding to the multi-channel input data.

18. The apparatus of claim 14, wherein
a bottleneck-based block, in which a size of input data thereof is equal to a size of output data thereof, comprises an SE block configured to receive, as an input, an output of a layer configured to perform a depthwise convolution operation.

19. The apparatus of claim 14, wherein
a bottleneck-based block, in which a size of input data thereof is different that a size of output data thereof, comprises a layer configured to perform a depthwise convolution operation of receiving, as an input, an output of an SE block.

20. The apparatus of claim 14, wherein
an activation function is not applied to output data of a layer of the bottleneck-based block that is configured to perform a depthwise convolution operation.
